(19) United States
(12) Patent Application Publication
(10) Pub. No.: US 2007/0061727 A1
(43) Pub. Date: Mar. 15, 2007

(54) Adaptive key frame extraction from video data

(75) Inventors: Lokesh R. Boregowda, Bangalore (IN); Anupama Rajagopal, Coimbatore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/227,386

(22) Filed: Sep. 15, 2005

(51) Int. Cl. G11B 27/00; H04N 5/14; H04N 5/445

(52) U.S. Cl. 715/723; 348/571; 725/37

(57) ABSTRACT

In some embodiments, the present invention is related to a method that includes determining difference frames between successive frames in video data and determining an energy value of each difference frame. The method further includes determining a cumulative energy mean for each difference frame and a predetermined number of previous difference frames and updating the energy value of each frame by removing the cumulative energy mean from the energy value of each difference frame. In addition, the method further includes identifying a temporal change in the energy value of each difference frame to extract key frames from video data. Identifying a temporal change in the energy value of each difference frame to extract key frames from the video data may include identifying difference frames that have an energy value greater than zero after the cumulative energy mean has been removed from the energy value of each difference frame.

### TECHNICAL FIELD

The present invention relates to the field of video processing, and in particular to extracting key frames from video data.

### BACKGROUND

Multimedia information is being used in an ever increasing number of applications. Some examples of multimedia information include text, image, graphic, audio and video.

Video is the most challenging form of multimedia as it contains information from all of the various media types as a single data stream. Digital video is becoming increasingly available due to the decreasing cost of storage devices, higher transmission rates and improved compression techniques.

One of drawbacks with using video data is that it is difficult to efficiently access and analyze video data due to a typical video's length and unstructured format. Therefore, video abstraction and summarization techniques are usually required in order to efficiently access and analyze video data.

A typical video clip usually includes a story structure that is reflected in the content of the video. The fundamental unit of production of video is the video “shot”. Several sequential video frames capture the continuous action of a video shot.

A scene is usually composed of a number of inter-related video shots that are unified by location or dramatic incident. As an example, a news program may be divided into stories with each story starting with a common visual cue. Each story may contain several shots and perhaps multiple scenes with each scene consisting of alternating shots of an interviewer and interviewee. The beginning (or ending) of a story in a news show may be signaled by some type of indicator, such as a shot of the story location or the news anchor.

Several techniques are available to summarize a long video sequence such that it is sometimes possible to access and analyze the video sequence. One technique is key frame selection. A key frame is a frame of video that can represent the salient content of a video shot. Depending on the complexity of a video shot, key frame selection may be used to extract one or more key frames from the video shot.

Some of the known key frame selection methods include a (i) shot boundary-based approach; (ii) visual content-based approach; (iii) motion analysis-based approach; or (iv) a shot activity-based approach. Each of these approaches attempts to divide a video sequence into video shots. Different shots are typically detected by measured changes from one video frame to another.

The shot boundary-based approach typically uses the first frame of each shot as the shot's key frame. Although the method is simple, the number of key frames for each shot is limited to one without any consideration as to the complexity of the video shot. The representative key frame that is discovered using this method is typically not sufficient to analyze the video data which is contained in the video shot.

The visual content-based approach typically uses multiple visual criteria to extract key frames. One of the criteria is shot-based criteria where the first frame of each shot will always be selected as a key frame and other key frames may be chosen depending on other criteria. Another of the criteria is color feature-based criteria where the current frame of the shot is compared against the last key frame. If significant color content changes occur, the current frame will be selected as a new key frame. The visual content-based approach also typically uses motion-based criteria. As an example, for a zooming-like shot at least the first and last frame will selected as key frames with one key frame representing a global view and the other key frame representing a more focused view.

The motion analysis-based approach typically includes computing the optical flow for each frame in a video shot and then calculating a simple motion metric based on the optical flow. The motion metric is then analyzed as a function of time to select key frames at one or more local minima of motion. The basis of this approach is that the key frames in a video shot are identified by a lack of motion because the camera stops on a new position, or the characters in a video shot hold their gestures to emphasize their importance.

The shot activity-based approach typically includes computing intra and reference histograms for each frame in a video shot and then computing an activity curve for each video shot. As with the motion analysis-based approach, the local minima are selected as the key frames because the basis of the approach is that the key frames in a video shot are identified by their lack of motion.

Existing key frame selection methods suffer from a variety of drawbacks depending on the type of approach that is used to select fey frames. The shot boundary-based and the visual content-based approaches to key frame selection are relatively fast. However, these types of approaches do not adequately capture the content of a video shot since the first frame in a video shot is not necessarily a key frame.

The motion analysis-based and the shot activity based approaches are more sophisticated due to their analysis of motion and activity. However, both of these types of approaches require extensive computations. In addition, the underlying basis of these approaches relating to local minima within a video shot is not necessarily correct.

### BRIEF DESCRIPTION OF THE DRAWINGS

FIG. 1 is a flowchart that illustrates a portion of an example method of analyzing video data.

FIG. 2 is a flowchart that illustrates an example method of analyzing video data.

FIG. 3 shows 15 example nonconsecutive frames of a sample indoor video data sequence.

FIG. 4 shows a zero-meaned displaced frame difference (DFD) energy plot as a function of each frame in the sample indoor video data sequence and a corresponding screen shot from the indoor video data sequence with the frame that is displayed in the screen shot identified in the DFD plot below.

FIG. 5 shows the same zero-meaned DFD energy plot that is shown in FIG. 4 with each of the frames which are shown in FIG. 3 identified on the DFD plot.

### DETAILED DESCRIPTION

In the following detailed description, reference is made to the accompanying drawings that show specific embodiments in which the invention may be practiced. These embodiments are described in sufficient detail to enable those skilled in the art to practice the invention. It is to be understood that the various embodiments of the invention, although different, are not necessarily mutually exclusive. A particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention.

Therefore, the following detailed description is not to be taken in a limiting sense, and the scope of the present invention is defined only by the appended claims along with the full range of equivalents to which the claims are entitled. In the drawings, like numerals refer to the same or similar functionality throughout the several views.

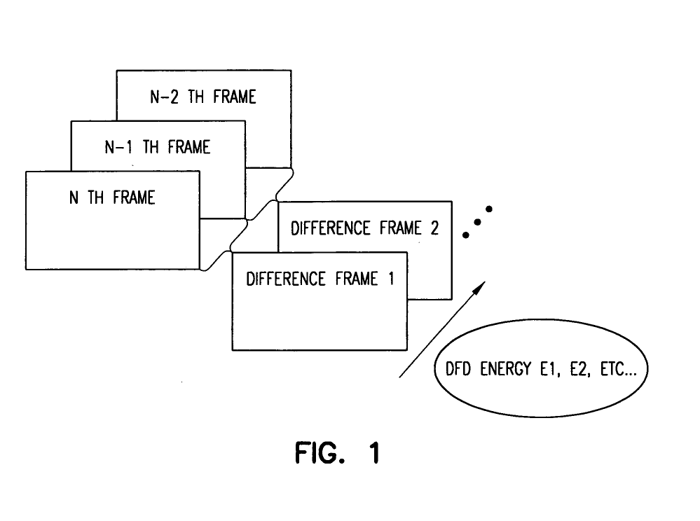

As shown in FIG. 1, some embodiments of the present invention analyze key frames by taking the energy of difference frames and then quantifying the energy relative to a cumulative mean of several difference frames. The difference frame is taken after zero-meaning the image to facilitate eliminating the frames without motion. As used herein, the “energy of difference frames” refers to [INVENTORS—PLEASE DEFINE ENERGY OF DIFFERENC FRAMES].

The cumulative mean is continually updated such that the cumulative energy mean is calculated for the energy value of the current difference frame and the mean energy of the previous N number of difference frames. As an example, N may be thirty so that the mean energy is calculated for the current frame and the previous 30 difference frames.

The cumulative energy mean may be slightly higher than the energy level for each difference frame. Zero-meaning the difference frame energy before finding the cumulative mean allows the key frames to be identified as those frames having their cumulative mean energy greater than zero.

Some embodiments of the invention use the displaced frame difference (DFD) energy between two successive video frames. Energy values are computed for the difference frames between the current and the next difference frame using an intensity value instead of the red (R), green (G) and blue (B) color channels. The cumulative mean value of the DFD Energy may then be calculated.

A self-derived threshold based on pseudo-mean prediction is used in selecting key frames. The self derived threshold dynamically adapts to the variation of motion between frames. Therefore, key frames may be selected from video data that includes high and/or low motion with equal success. The selected key frames may then be analyzed to determine key-shots within a given video sequence to help provide effective video summarization.

The ever-evolving threshold provides consistency for all video shot scenarios unlike other systems that use a fixed threshold, or an adaptive threshold that does not provide consistent results in all types of video shot scenarios. Updating the energy mean in the manner described herein provides for improved key frame selection. In addition, the displaced difference frames are pixel domains that require reduced computing requirements in order to determine the displaced difference frames.

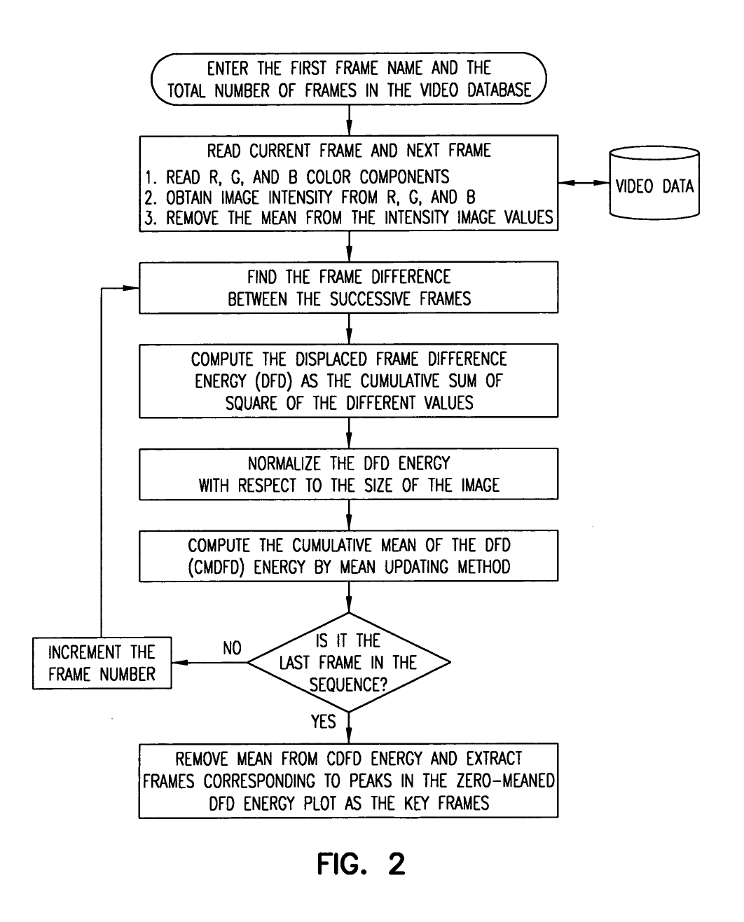

A flowchart illustrating an example method of analyzing video data is shown in FIG. 2. The method may include entering and/or determining the total number of frames in a video database. The method may then include reading the current frame and the next frame.

In some embodiments, reading the current and the next frame may include reading red (R), green (G) and blue (B) color components and then obtaining image intensity measurements from the R, G & B components. The mean may then removed from the values that were determined during the image intensity measurements.

The method may then include finding the difference frames between successive frames and then computing the displaced difference frame energy (DFD) as the cumulative sum of the square of the difference values. In some embodiments, the DFD energy may then be normalized with respect to the size of the image.

The cumulative mean of the DFD may then be computed for the energy value of the current difference frame and the mean energy of the previous N number of difference frames. Unless a frame is not the last frame in the video sequence, the next successive frame is then compared to the previous frame to calculate the DFD and then update the cumulative mean.

Once the difference frames and the DFD relative to the last frame in the video sequence are determined, the cumulative mean is updated for the last time. The cumulative mean is then removed from the DFD energy plot for each frame. Note that the cumulative mean energy changes with each difference frame as it depends on the energy value of the current difference frame and N previous difference frames. The key frames may then be determined because the key frames correspond to peaks in the zero-meaned DFD energy plot as a function of particular frames.

### EXPERIMENTAL RESULTS

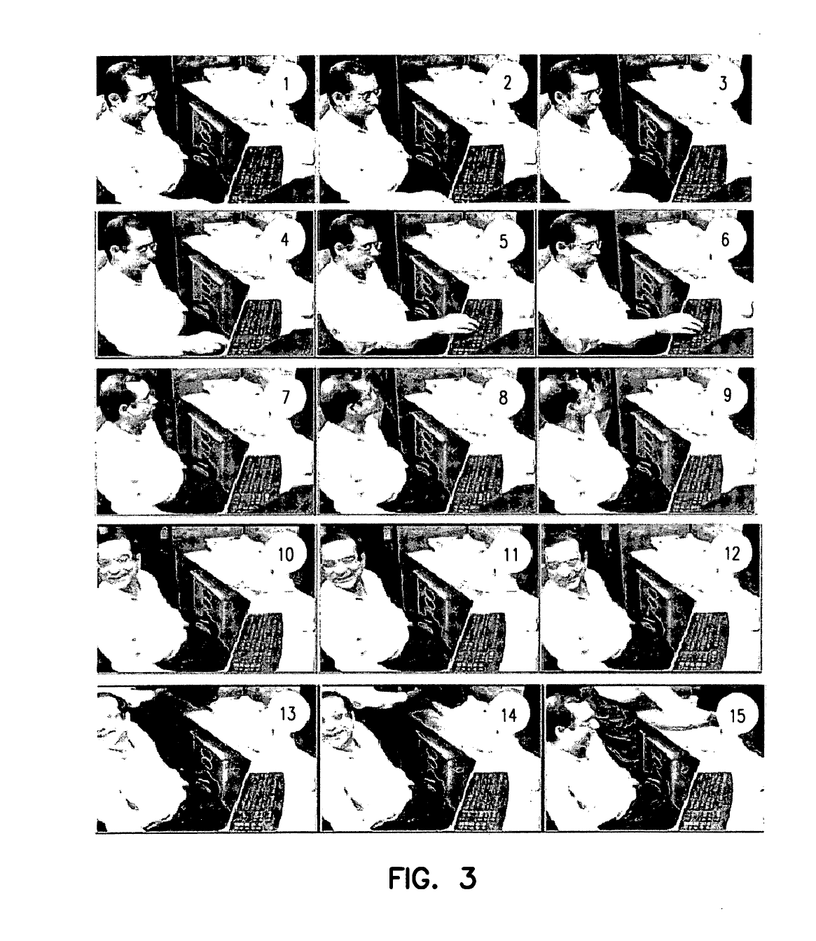

Experimental results for an example method of analyzing video data are illustrated in FIGS. 3-5. The results relate to a sample indoor video data sequence that consists of varying levels of motion activity (i.e., normal activity with changed activity due to human foreground motion and background motion).

FIG. 3 shows 15 example nonconsecutive frames of the sample indoor video data sequence. The 15 frames that are illustrated include some normal frames and some key frames.

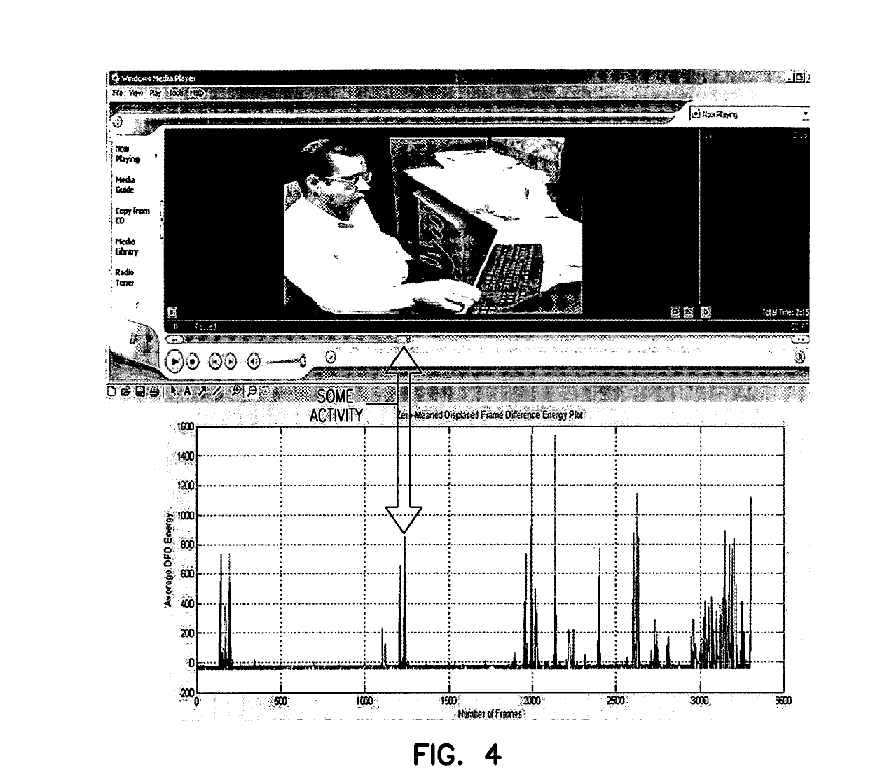

FIG. 4 shows a zero-meaned DFD plot as a function of all of the frames in the sample indoor video data sequence and a corresponding screen shot of one of the frames in the indoor video data sequence. The frame that is displayed in the screen shot is identified in the DFD plot below. The high DFD of the selected frame illustrates that some activity is occurring in the indoor video data sequence.

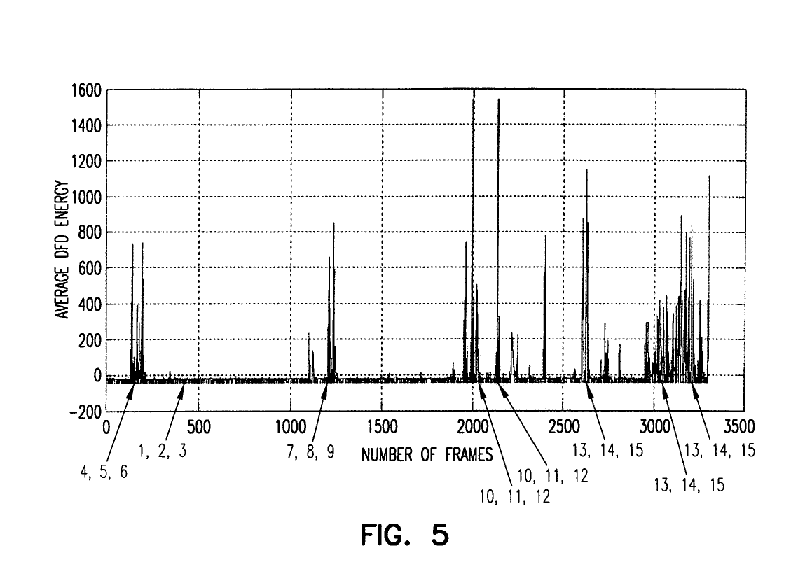

FIG. 5 shows the same zero-meaned DFD energy plot that is shown in FIG. 4 with each of the frames which are shown in FIG. 3 identified on the DFD plot. Frames 1, 2 and 3 are non-key frames that show a person viewing his desktop monitor (i.e., low activity, low motion). Frames 4, 5 and 6 are key frames that show the person lifting his hand to use the keyboard/mouse (i.e., increased activity, significant motion). Frames 7, 8 and 9 are key frames that show the person changing focus of attention towards his left (i.e., changed activity, medium foreground motion). Frames 10, 11 and 12 are key frames that show the person turning to his right & laughing (i.e., change in activity, large foreground motion). Frames 13, 14 and 15 are key frames that show the person continuing to laugh and another person entering the scene to try to pick some object from the table (i.e., changed background activity, large background motion).

The key frames were extracted in such a manner that the data crunching was about 55% to 65% on average for a typical indoor video sequence and about 35% to 45% on average for a typical outdoor video sequence. Therefore, some embodiments of the invention may be suitable for a variety of video data crunching, archiving, indexing and retrieval applications. Since there is typically a huge storage space requirement in most video monitoring and surveillance applications, key-frame based indexing as described herein may reduce the amount of searching that is necessary during a video data scan (e.g., as part of a security and/or investigation process).

In some example embodiments, the present invention is related to a method that includes determining difference frames between successive frames in a video data sequence and determining an energy level of each difference frame. The method further includes determining a cumulative energy mean for each frame and a predetermined number of previous difference frames and updating the energy level of each frame by removing the cumulative energy mean from the energy value of each difference frame. In addition, the method further includes identifying a temporal change in the energy level of each difference frame to extract key frames from the video data sequence.

Embodiments are contemplated where determining a frame difference between successive frames in a video data sequence includes determining a frame difference between successive frames in a video data sequence based on intensity of color components in successive frames, and determining the cumulative energy mean of each frame and a predetermined number of previous difference frames includes determining the cumulative energy mean of each frame and thirty previous difference frames. In addition, determining an energy level of each difference frame may include determining a normalized energy level for each difference frame and/or determining an energy level of pixels that make up each difference frame.

Embodiments are also contemplated where determining an energy level of each difference frame includes computing the energy levels as the cumulative sum of the square of the energy difference values, and determining the cumulative energy mean for each frame and a predetermined number of previous difference frames includes determining whether each frame is the last frame. In addition, identifying a temporal change in the energy level of each difference frame to extract key frames from the video data sequence may include identifying difference frames that have an energy level greater than zero after the cumulative energy mean has been removed from the energy value of each difference frame.

It should be noted that updating the energy level of each frame by removing the cumulative energy mean from the energy value of each difference frame may include creating a DFD energy plot as a function of at least some of the difference frames in the video data sequence with the cumulative energy mean removed from the energy level of each difference frame, and identifying a temporal change in the energy level of each difference frame to extract key frames from the video data sequence may include identifying peaks in the DFD energy plot.

In some example embodiments, the present invention is related to a machine readable medium with instructions thereon to cause a machine to execute a process that includes (i) determining difference frames between successive frames in a video data sequence; (ii) determining an energy level of each difference frame; (iii) determining a cumulative energy mean for each difference frame and a predetermined number of previous difference frames; (iv) updating the energy level of each frame by removing the cumulative energy mean from the energy value of each difference frame; and (v) identifying a temporal change in the energy level of each difference frame to extract key frames from the video data sequence.

Embodiments are contemplated where the machine readable medium has instructions thereon to cause a machine to execute a process that includes (i) determining difference frames between successive frames in a video data sequence based on intensity of color components in the successive frames; (ii) determining the cumulative energy mean of each frame and thirty previous difference frames; (iii) determining a normalized energy level for each difference frame and/or determining an energy level of pixels that make up each difference frame; (iv) computing the energy levels as the cumulative sum of the square of the energy difference values; (v) determining whether each frame is the last frame; and/or (vi) identifying difference frames that have an energy level greater than zero after the cumulative energy mean has been removed from the energy value of each difference frame. It should be noted that the machine readable medium may also have instructions thereon to cause a machine to execute a process that includes creating a DFD energy plot as a function of some (or all) of the frames in the video data sequence with the cumulative energy mean removed from the energy level of each difference frame and then identifying peaks in the DFD energy plot.

While the invention has been described in detail with respect to specific embodiments, it will be appreciated that there are variations of, and equivalents to these embodiments. Accordingly, the scope of the present invention should be determined by the appended claims and any equivalents thereto.

1. A method comprising:
determining difference frames between successive frames in a video data sequence;
determining an energy value of each difference frame;
determining a cumulative energy mean for each difference frame and a predetermined number of previous difference frames;
updating the energy value of each difference frame by removing the cumulative energy mean from the energy value of each difference frame; and
identifying a temporal change in the energy value of each difference frame to extract key frames from the video data sequence.

2. The method of claim 1, wherein determining difference frames between successive frames in a video data sequence includes determining difference frames between successive frames in a video data sequence based on intensity of color components in successive frames.

3. The method of claim 1 wherein determining an energy value of each difference frame includes determining a normalized energy value for each difference frame.

4. The method of claim 1, wherein determining the cumulative energy mean of each difference frame and a predetermined number of previous difference frames includes determining the cumulative energy mean of each difference frame and thirty previous difference frames.

5. The method of claim 1, wherein determining an energy value of each difference frame includes computing the energy values as the cumulative sum of the square of the energy difference values.

6. The method of claim 1, wherein updating the energy value of each difference frame by removing the cumulative energy mean from the energy value of each difference frame includes creating a DFD energy plot as a function of at least some of the difference frames in the video data sequence with the cumulative energy mean removed from the energy value of each difference frame.

7. The method of claim 6, wherein identifying a temporal change in the energy value of each difference frame to extract key frames from the video data sequence includes identifying peaks in the DFD energy plot.

8. The method of claim 1, wherein identifying a temporal change in the energy value of each difference frame to extract key frames from the video data sequence includes identifying difference frames that have an energy value greater than zero after the cumulative energy mean has been removed from the energy value of each difference frame.

9. The method of claim 1, wherein determining the cumulative energy mean for each difference frame and a predetermined number of previous difference frames includes determining whether each difference frame is the last frame.

10. The method of claim 1, wherein determining an energy value of each difference frame includes determining an energy value of pixels that make up each difference frame.

11. A machine readable medium including instructions thereon to cause a machine to execute a process comprising:
determining difference frames between successive frames in a video data sequence;
determining an energy value of each difference frame;
determining a cumulative energy mean for each difference frame and a predetermined number of previous difference frames;
updating the energy value of each difference frame by removing the cumulative energy mean from the energy value of each difference frame; and
identifying a temporal change in the energy value of each difference frame to extract key frames from the video data sequence.

12. The machine readable medium of claim 11, wherein determining difference frames between successive frames in a video data sequence includes determining difference frames between successive frames in a video data sequence based on intensity of color components in successive frames.

13. The machine readable medium of claim 11, wherein determining an energy value of each difference frame includes determining a normalized energy value of pixels that make up each difference frame.

14. The machine readable medium of claim 11, wherein determining the cumulative energy mean of each difference frame and a predetermined number of previous difference frames includes determining the cumulative energy mean of each difference frame and thirty previous difference frames.

15. The machine readable medium of claim 11, wherein determining the cumulative energy mean for each difference frame and a predetermined number of previous difference frames includes determining whether each difference frame is the last frame.

16. The machine readable medium of claim 11, wherein updating the energy value of each difference frame by removing the cumulative energy mean from the energy value of each difference frame includes creating a DFD energy plot as a function of at least some of the difference frames in the video data sequence with the cumulative energy mean removed from the energy value for each difference frame, and identifying a temporal change in the energy value of each difference frame to extract key frames from the video data sequence includes identifying peaks in the DFD energy plot.

17. The machine readable medium of claim 11, wherein identifying a temporal change in the energy value of each difference frame to extract key frames from the video data sequence includes identifying difference frames that have an energy value greater than zero after the cumulative energy mean has been removed from the energy value of each difference frame.

18. A method comprising:
determining difference frames between successive frames in a video data sequence based on intensity of color components in the successive frames;
determining a normalized energy value for pixels that make up each difference frame;
determining a cumulative energy mean for each difference frame and a predetermined number of previous difference frames;
updating the energy value of each difference frame by removing the cumulative energy mean from the energy value of each difference frame; and
extracting key frames from the video data sequence by identifying difference frames that have an energy value greater than zero after the cumulative energy mean has been removed from the energy value of each difference frame.

19. The method of claim 18, wherein updating the energy value of each difference frame by removing the cumulative energy mean from the energy value of each difference frame includes creating a DFD energy plot as a function of at least some of the difference frames in the video data sequence with the cumulative energy mean removed from the energy value for each difference frame, and extracting key frames from the video data sequence by identifying difference frames that have an energy value greater than zero includes identifying peaks in the DFD energy plot.

20. The method of claim 18, wherein determining the cumulative energy mean of each difference frame and a predetermined number of previous difference frames includes determining the cumulative energy mean of each frame and thirty previous difference frames.
